(19) United States
(12) Patent Application Publication
(10) Pub. No.: US 2004/0130114 A1
(43) Pub. Date: Jul. 8, 2004

(54) Steering device for an agricultural harvesting machine

(76) Inventor: Dirk Weichholdt, Sarreguemines (FR)

Correspondence Address: Kevin J. Moriarty, Patent Department, DEERE & COMPANY, One John Deere Place, Moline, IL, 61265-8098, US

(21) Appl. No.: 10/663,336

(22) Filed: Sep. 16, 2003

(30) Foreign Application Priority Data
Oct. 12, 2002 (DE) 102 47 699.3

(51) Int. Cl. B62D 17/00

(52) U.S. Cl. 280/86.751; 280/124.111

(57) ABSTRACT

A steering device for an agricultural harvesting machine having steerable rear wheels. The rear wheels are mounted to a rear axle. The steering device comprises a pivot support mounted on the rear axle and a wheel carrier that is pivotally supported on the pivot support. The rear wheel is rotaively supported on the wheel carrier and defines a rotational axis. The wheel carrier is pivoted relative to the pivot support about a pivot axis for steering the vehicle. The pivot axis is inwardly inclined toward the longitudinal central plane of the harvesting machine and/or rearward with respect to the normal forward driving direction

### FIELD OF THE INVENTION

The present invention is directed to a steering device for an agricultural harvesting machine, wherein the steering device comprises a pivot support and a wheel carrier that define a pivot axis that is inwardly inclined toward the longitudinal central plane of the harvesting machine and/or rearward with respect to the normal forward driving direction

### BACKGROUND OF THE INVENTION

Many types of self-propelled agricultural harvesting machines, for example combines and forage harvesters, are equipped with driven front wheels and steerable rear wheels. Since the width of the harvesting machines is subject to legal restrictions, the width of the tires on the rear wheels, as well as their pivoting range that defines the maneuverability, limits the available space between the rear wheels in which structural components of the harvesting machine could be accommodated. It is desirable in many instances to make this space as large as possible, for example, in order to install screens between the rear wheels of a combine harvester.

U.S. Pat. No. 6,267,198 discloses an agricultural harvesting machine having steerable rear wheels. The pivot pin for the steerable rear wheels is located in front of the rotational axis of the rear wheel. Due to this measure, the largest portion of the wheel is situated behind the pivot axis. Sufficient space for the steering motion of this portion of the wheel is available behind the chassis of the harvesting machine. The front portion of the wheel which approaches the chassis when steering is significantly shorter than the rear portion, such that larger steering angles can be realized and the components of the harvesting machine that are situated between the rear wheels can be wider than in a steering arrangement in which the wheel is pivoted about a pivot axis that intersects the rotational axis of the wheel. However, the disclosed steering device requires higher steering torques due to the trailing relationship between the pivot axis and the rotational axis of the wheel.

DE 197 49 195 C and U.S. Pat. No. 5,454,444 disclose harvesting machines in which the wheels of the front axles are steerable. The pivot axes, about which the front wheels are turned when steering are angled rearward. Due to the fundamentally different configuration, these publications do not inspire a person skilled in the art to improve the above-described steering device.

### SUMMARY OF THE INVENTION

It is an object of the present invention to provide an improved steering device for harvesting machines having steerable rear wheels.

The harvesting machine has driven front wheels that are typically mounted on the chassis such that they cannot be steered. Viewed in the normal forward driving direction of the harvesting machine, a rear axle that carries steerable rear wheels that are arranged behind the front wheels. The rear wheels may either be driven or not driven. The rear wheels are respectively supported in a rotatable fashion on a wheel carrier, about which the wheels rotate when the harvesting machine is in motion. The wheel carriers are respectively coupled to pivot supports that are arranged on the rear axle. The wheel carrier is pivoted on the pivot support about a pivot axis when steering. The invention proposes that the pivot axis be inclined inward and/or rearward relative to the normal forward driving direction. If the pivot axis is inclined inward, an upper mounting point of the wheel carrier is preferably arranged on the pivot support farther inward than a corresponding lower mounting point (closer to the central longitudinal plane of the harvesting machine) relative to the horizontal direction transverse to the driving direction. Due to this provision, the upper side of the rear wheel is inclined outward when the wheel is turned from the straight ahead position. This means that additional space is available between the rear wheels. The pivot axis is alternatively or additionally inclined rearward, in such a manner that an upper mounting point of the wheel carrier is arranged on the pivot support farther to the rear than a corresponding lower mounting point, relative to the normal forward driving direction. This incline makes it possible to reduce the torques required to steer the harvesting machine.

The invention makes it possible to lower the required steering torques and to enlarge the available space between the wheels. If the pivot support is offset forward, relative to the rotational axis of the wheel, in the forward driving direction, the steering torques are comparable to those required without this offset arrangement, and a self-stabilization of the steering device is also achieved.

It is preferred to incline the rotational axis of the rear wheel downward, relative to a horizontal line, in its straight position, i.e., the rear wheel is cambered in order to achieve an additional self-stabilization of the steering device. This also results in an enlargement of the space available above the wheels in the intermediate space between them.

The steering device according to the invention is particularly suitable for self-propelled harvesting machines such as combines, forage harvesters or self-propelled balers.

### BRIEF DESCRIPTION OF THE DRAWINGS

FIG. 1 is a side view of a harvesting machine with a steering device according to the invention.

FIG. 2 is a perspective view of the steering device, viewed from the front.

FIG. 3 is a front view of part of the steering device.

FIG. 4 is a side view of part of the steering device.

### DETAILED DESCRIPTION

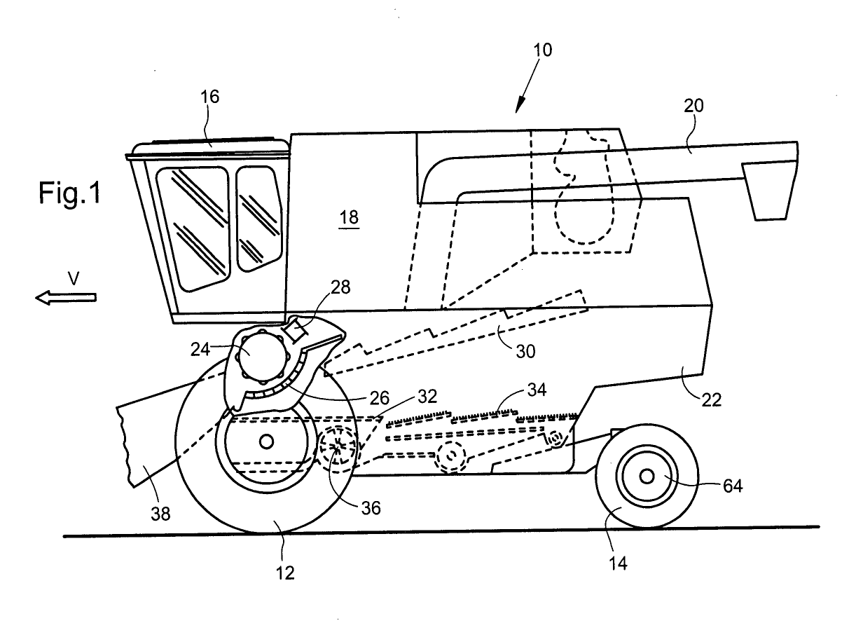

The harvesting machine 10 shown in FIG. 1 is a combine that is supported on driven front wheels 12 and steerable rear wheels 14. The combine is provided with a driver's cabin 16 from which a driver operates the combine. During harvesting operations and when driving on roads, the harvesting machine 10 is propelled in the normal forward driving direction V that is defined by the viewing direction of the driver in the driver's cabin 16. However, the harvesting machine can also be driven in reverse to position the vehicle. A grain tank 18 is located behind the driver's cabin 16. The grain tank 18 is used to temporarily store accumulated crop material. The crop material is discharged from the grain tank 18 by an unloading auger 20. The grain tank 18 is supported on a chassis 22, within which the harvested material is separated into its large and small components by means of a threshing cylinder 24, a threshing concave 26 and a beater 28. Grain trapped in threshed crop material is released by the downstream straw walkers 30. Grain and chaff falling from the threshing concave 26 and straw walkers 30 is deposited on a grain pan 32. The grain pan 32 directs the grain and chaff to the cleaning system for separating the grain from the chaff. The cleaning system is provided with screens 34 through which the clean grain falls to the floor of the combine; and from which the chaff is blown out the back of the combine by cleaning fan 36. The clean grain is conveyed from the floor to the grain tank by an elevator, not shown. The large crop components other than grain are dropped to the ground by the straw walkers 30. The crop is harvested by a harvesting assembly, not shown, that directs the harvested crop to a feeder house 38. The feeder house 38 in turn directs the harvested crop to the threshing assembly. In the following description, all directional indications such as front, rear, top and bottom are made with reference to the normal forward driving direction V.

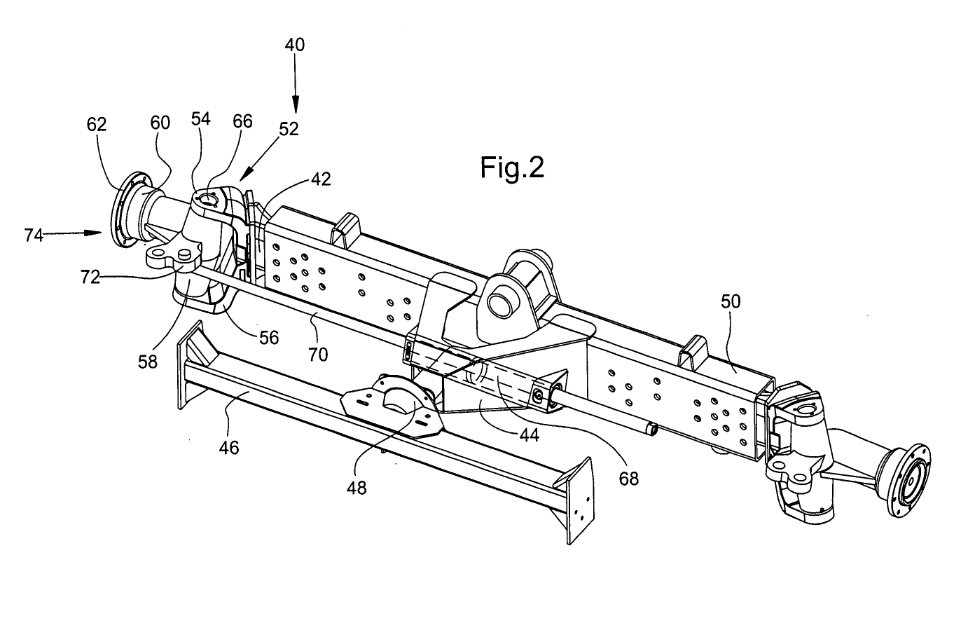

The driven front wheels 12 are conventionally arranged rigidly on the chassis 22, by means of a spring suspension or, in case of a hillside combine, by an assembly that provides a mechanism for adjusting the height of the wheels 12. However, the driven front wheels cannot be steered, so that their mounting requires no additional explanation. The rear wheels 14 are mounted on the chassis 22 by means of the steering device that is illustrated in FIGS. 2-4 and is identified by the reference symbol 40. The steering device 40 comprises a rear axle 42 that extends transverse to the forward driving direction V and is coupled to a frame construction 46 by means of a pendulum suspension 44. Another pendulum suspension 80 (FIG. 4) is situated above the central section of the axle 42 and serves to support the axle 42 on the chassis 22. The pendulum suspensions 44 and 80 make it possible for the rear axle 42 to pivot about an axis 48 that extends in the forward driving direction V when the combine is driven over uneven terrain (or when operating a hillside combine with front wheels 12 of adjustable height on a sloping field). The rear axle 42 is arranged within and mounted on a crossbeam 50 that is connected to the pendulum suspension 44.

The two ends of the rear axle 42 respectively carry a yoke-shaped pivot support 52 that comprises an upper arm 54 and a lower arm 56 arranged beneath the upper arm 54. A hollow member 58 of a wheel carrier 74 extends between the arms 54 and 56, with said wheel carrier being connected to a hub 60 that carries a flange 62. The flange 62 is mounted on the hollow member 58 by means of the hub 60 such that it is rotatable about its axis. The rim 64 of the right rear wheel 14 is mounted on the flange 62. The axis of the flange 62 coincides with the rotational axis of the wheel 12. The hollow member 58 of the wheel carrier 74 is supported on the lower arm 56 and on the upper arm 54 of the pivot support 52. For this purpose, a steering pin 66, which has the shape of a regular cylinder and is arranged coaxially with the opening of the hollow member 58 of the wheel carrier 74, extends through the lower arm 56, the opening of the hollow member 58 and the upper arm 54. The steering pin 66 defines the pivot axis of the wheel carrier 74 relative to the pivot support 52. The steering pin 66 may be joined to the hollow member 58 or the pivot support 52.

In order to provide a better overview, only the right pivot support 52 and the right wheel carrier 74, relative to the forward driving direction, are shown in FIG. 2; the oppositely arranged complementary elements for receiving the left rear wheel 14 are realized in mirror-image fashion. A steering cylinder 68 that is linked by means of a rod 70 to a cantilevered bracket 72 connected to the hollow member 58 is arranged between the pendulum suspension 44 and the crossbeam 50. The steering cylinder 68 pivots the wheel carrier 74, relative to the pivot support 74, about the pivot axis defined by the pivot pin 66 in order to achieve steering movement of the rear wheel 12.

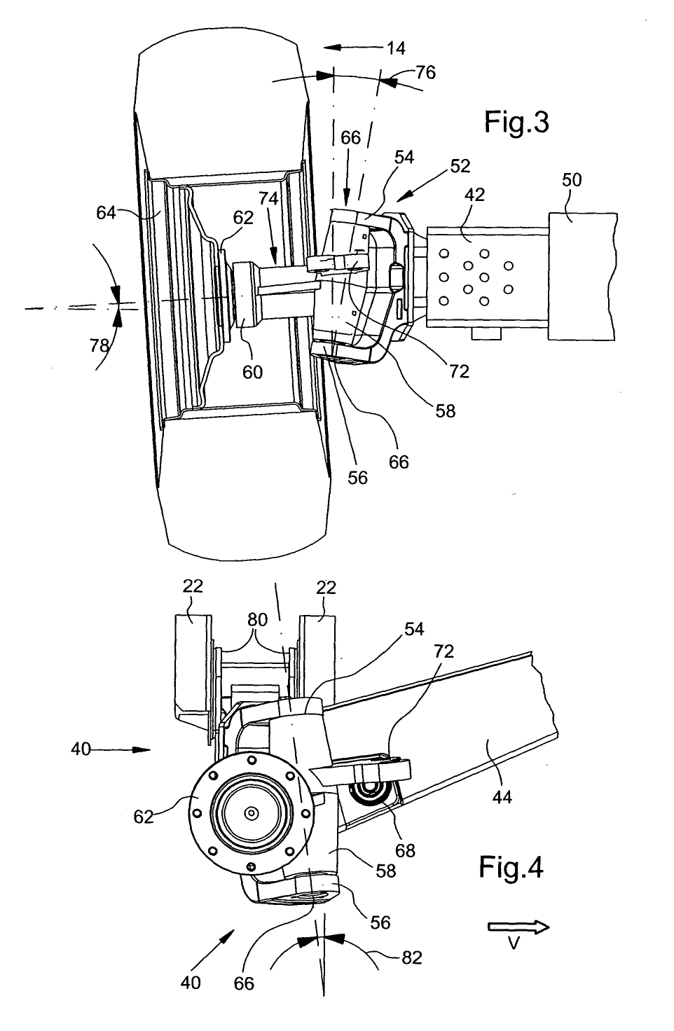

FIG. 3 shows a front view of part of the steering device 40. According to this figure, the pivot axis of the wheel carrier 74 on the pivot support 52 is not oriented in exactly the vertical direction, but rather extends at an angle 76 of approximately 10 degrees. The lower arm 56 consequently extends farther outward than does the upper arm 54, such that the upper mounting point of the wheel carrier 74 on the pivot support 52 lies closer to the central longitudinal plane of the harvesting machine 10 than does the lower mounting point of the wheel carrier 74 on the pivot support 52. In addition, the rotational axis of the wheel 14, which is defined by the hub 60 and the flange 62, does not extend horizontally and parallel to the axle 42, but rather is angled downward at an angle 78 of approximately 10 degrees. In the straight position of the wheel that is illustrated in FIG. 3, the lowest point of the wheel 14 (contact point with the ground) is situated farther inward, i.e., closer to the central longitudinal plane of the harvesting machine, than is the upper region of the wheel 14.

FIG. 4 shows a side view of the steering device 40. According to this figure, the steering pin 66 and consequently the pivot axis are additionally inclined rearward by an angle 82 of approximately 10 degrees. The mounting point of the hollow member 58 of the wheel carrier 74 on the lower arm 56 is arranged farther forward, relative to the forward driving direction V, than is the mounting point of the hollow member 58 on the upper arm 54. The pivot axis consequently is inclined rearward in the plane that extends in the forward driving direction V. In addition, the two aforementioned mounting points of the wheel carrier 74 on the pivot support 52 are situated in front of the rotational axis of the wheel 14, relative to the forward driving direction V, in order to enlarge the space available between the rear wheels 14 for structural elements of the harvesting machine 10 at a given steering radius (or vice versa). It would also be conceivable to reduce the forward offset of the pivot axis relative to the rotational axis of the wheel 14 such that in other embodiments only one (or none) of the mounting points of the wheel carrier on the pivot support would be situated in front of the rotational axis of the wheel 14.

The invention consequently proposes that the pivot axis be offset forward relative to the rotational axis of the rear wheel 14, inclined rearward by an angle 82 (FIG. 4) and inclined inward by an angle 76 (FIG. 3). In connection with the camber of the wheels 14 by the angle 78 (FIG. 3), these three angles cause a self-stabilization of the steering device 40 and reduce the steering torques. The above-indicated angles merely represent values given as examples, and can be varied in accordance with respective requirements.

Having described the illustrated embodiment, it will become apparent that various modifications can be made without departing from the scope of the invention as defined in the accompanying claims.

1. A steering device for an agricultural harvesting machine having a longitudinal central plane, the agricultural harvesting machine can be propelled in a normal forward driving direction and comprises a pair of front wheels as well as a pair of rear wheels mounted to a rear axle, the rear wheels are arranged behind the front wheels relative to the normal forward driving direction, wherein the steering device comprises a pivot support that is mounted on the rear axle, as well as a wheel carrier that is pivotally supported on the pivot support and on which a rear wheel is rotatably supported such that the rear wheel is rotatable about a rotational axis, the wheel carrier can be pivoted relative to the pivot support about a pivot axis to steer the vehicle, characterized by the fact that the pivot axis is inwardly inclined toward the longitudinal central plane of the harvesting machine and inclined rearward relative to the normal forward driving direction.

2. The steering device as defined by claim 1 wherein the pivot support comprises a yoke having an upper arm and a lower arm, the wheel carrier is pivotally mounted between the upper and lower arms by a steering pin, the steering pin and the upper and lower arms define two mounting points of the wheel carrier.

3. The steering device as defined by claim 2 wherein one of the mounting points of the wheel carrier is offset forward of the rotational axis of the rear wheel relative to the forward driving direction.

4. The steering device as defined by claim 2 wherein both mounting points of the wheel carrier are offset forward of the rotational axis of the rear wheel relative to the forward driving direction.

5. The steering device as defined by claim 1 wherein each of the rear wheels have an upper side and a lower side, when the rear wheels are in a straight ahead position the rotational axis of the rear wheel is arranged at an angle to the horizontal such that the upper side of the rear wheel is situated farther outward from the longitudinal center plane than the lower side.

6. The steering device as defined by claim 1 wherein the agricultural harvesting vehicle is a combine.

7. A steering device for an agricultural harvesting machine having a longitudinal central plane, the agricultural harvesting machine can be propelled in a normal forward driving direction and comprises a pair of front wheels as well as a pair of rear wheels mounted to a rear axle, the rear wheels are arranged behind the front wheels relative to the normal forward driving direction, wherein the steering device comprises a pivot support that is mounted on the rear axle, as well as a wheel carrier that is pivotally supported on the pivot support and on which a rear wheel is rotatably supported such that the rear wheel is rotatable about a rotational axis, the wheel carrier can be pivoted relative to the pivot support about a pivot axis to steer the vehicle, characterized by the fact that the pivot axis is inwardly inclined toward the longitudinal central plane of the harvesting machine.

8. The steering device as defined by claim 7 wherein the pivot support comprises a yoke having an upper arm and a lower arm, the wheel carrier is pivotally mounted between the upper and lower arms by a steering pin, the steering pin and the upper and lower arms define two mounting points of the wheel carrier.

9. The steering device as defined by claim 8 wherein one of the mounting points of the wheel carrier is offset forward of the rotational axis of the rear wheel relative to the forward driving direction.

10. The steering device as defined by claim 8 wherein both mounting points of the wheel carrier are offset forward of the rotational axis of the rear wheel relative to the forward driving direction.

11. The steering device as defined by claim 7 wherein each of the rear wheels have an upper side and a lower side, when the rear wheels are in a straight ahead position the rotational axis of the rear wheel is arranged at an angle to the horizontal such that the upper side of the rear wheel is situated farther outward from the longitudinal center plane than the lower side.

12. The steering device as defined by claim 7 wherein the agricultural harvesting vehicle is a combine.

13. A steering device for an agricultural harvesting machine having a longitudinal central plane, the agricultural harvesting machine can be propelled in a normal forward driving direction and comprises a pair of front wheels as well as a pair of rear wheels mounted to a rear axle, the rear wheels are arranged behind the front wheels relative to the normal forward driving direction, wherein the steering device comprises a pivot support that is mounted on the rear axle, as well as a wheel carrier that is pivotally supported on the pivot support and on which a rear wheel is rotatably supported such that the rear wheel is rotatable about a rotational axis, the wheel carrier can be pivoted relative to the pivot support about a pivot axis to steer the vehicle, characterized by the fact that the pivot axis is inclined rearward relative to the normal forward driving direction.

14. The steering device as defined by claim 13 wherein the pivot support comprises a yoke having an upper arm and a lower arm, the wheel carrier is pivotally mounted between the upper and lower arms by a steering pin, the steering pin and the upper and lower arms define two mounting points of the wheel carrier.

15. The steering device as defined by claim 14 wherein one of the mounting points of the wheel carrier is offset forward of the rotational axis of the rear wheel relative to the forward driving direction.

16. The steering device as defined by claim 14 wherein both mounting points of the wheel carrier are offset forward of the rotational axis of the rear wheel relative to the forward driving direction.

17. The steering device as defined by claim 13 wherein each of the rear wheels have an upper side and a lower side, when the rear wheels are in a straight ahead position the rotational axis of the rear wheel is arranged at an angle to the horizontal such that the upper side of the rear wheel is situated farther outward from the longitudinal center plane than the lower side.

18. The steering device as defined by claim 13 wherein the agricultural harvesting vehicle is a combine.
